(19) United States
(12) Patent Application Publication
(10) Pub. No.: US 2008/0126246 A1
(43) Pub. Date: May 29, 2008

(54) Method for aggregating and selling independent sales offices and merchant level sales representatives

(76) Inventors: Robert E. Burr, Canton, MA (US); Edmund C. Burr, Canton, MA (US)

Correspondence Address: LAMBERT & ASSOCIATES, P.L.L.C., 92 STATE STREET, BOSTON, MA, 02109-2004, US

(21) Appl. No.: 11/605,548

(22) Filed: Nov. 29, 2006

(51) Int. Cl. G06Q 40/00

(52) U.S. Cl. 705/39

(57) ABSTRACT

A business method of aggregating and selling Independent Sales Offices and Merchant Level Sales Representatives is disclosed. A preferred embodiment involves having a business, which is familiar with transactions involving Independent Sales Offices and Merchant Level Sales Representatives determine who are interested in selling their book of clients and sorting them according to risk, merchant type and banking agreements. After sorting Independent Sales Offices and Merchant Level Sales Representatives that have common traits will be grouped together and sold for a higher price than they would obtain if sold individually.

### FIELD OF THE INVENTION

The present invention relates to a system and method of locating entities such as Independent Sales Offices and Merchant Level Sales Representatives and facilitating these entities to aggregate their individual residual streams in order to add technical and retail value to said individual residual streams.

### BACKGROUND OF THE INVENTION

The current method of selling residuals by an ISO or MLS requires the individual ISO or MLS to locate a buyer and negotiate the agreement. ISO/MLS's are compensated based upon the number of merchants and monthly residual stream. An ISO/MLS looking to sell their residual stream is limited to their knowledge and skill in the art of acquisitions time available to perform the search and continue revenue-generating activities.

Review applicable patents in the industry, U.S. Pat. No. 7,117,165 to Adams illustrates A system patent where an operator states what kind of resource purchase they want to make and the computer checks it against certain parameters before giving approval and then recording the transaction. Additionally, U.S. Pat. No. 5,970,475 to Barnes illustrates a system and method patent where buyers and sellers can go to a certain server and ease the process of matching up the right sellers with the right buyers. Also, U.S. Pat. No. 5,592,375 to Salmon, illustrates a system patent that makes it easier for buyers and sellers to find each other online. A database contains information for both parties so that each side can look for characteristics they are looking for in the other party.

Furthermore, U.S. Pat. No. 5,224,034 to Katz illustrates a system patent that automates the process of grouping together buyers that are looking for the same goods so they can buy in bulk together and save money. U.S. Pat. No. 4,799,156 to Shavit illustrates a system patent that covers an interactive database where buyers and sellers can meet in real-time after providing a validating access code to the system.

### SUMMARY OF INVENTION

The present invention facilitates methods of acquiring multiple ISO/MLS's. Thus, it is an object of the present invention to afford the buyer access to ISO/MLS's from the same industries, possessing the same level of risk which would be bundled together such that the buyer does not have to search and gather information on the individual ISO/MLS's.

Furthermore, it is object of the instant invention to provide the seller the ability to forward their information to a service, which will aggregate several like businesses together, rather than having to procure and meet potential buyers themselves.

Additionally, it is an object of the instant invention to endow the seller with increased bargaining power as the aggregation of multiple ISO/MLS's being sold together which will yield greater leverage than selling as an individual. Moreover, it is an object of the present invention to generate greater profits as a buyer will be willing to pay more for the convenience of acquiring multiple ISO/MLS's in one transaction.

Other and further objects, aims, purposes, features, advantages, embodiments, usages and the like will be apparent to those skilled in the art from the present specification taken with the accompanying drawings and the appended claims.

These together with other objects of the invention, along with the various features of novelty which characterize the invention, are pointed out with particularity in the claims annexed to and forming a part of this disclosure. The invention is not limited to the embodiments described herein, thus reference should be made to the accompanying drawings and descriptive matter in which the preferred embodiments of the invention are illustrated.

### BRIEF DESCRIPTION OF THE DRAWINGS

FIG. 1 is a flow chart showing illustrating how an individual ISO/MLS would currently sell their book of clients in past systems.

FIG. 2 is a flow chart of the instant business method for acquiring multiple ISO/MLS's at one time, depicting the difference in aggregating multiple like businesses while also illustrating the lesser work required to be performed by the individual ISO/MLS.

### DETAILED DESCRIPTION OF PREFERRED EMBODIMENT

The present invention exhibits a system and method, which enables individual ISO's and MLS's to generate a greater profit from the sale of residuals without the need to research potential buyers, negotiate lengthy contracts and consult counsel for the interpretation of said contracts. The instant invention increases revenue by aggregating multiple ISO's and MLS's together. The system allows the ISO's and MLS's to enter into an option to sell agreement that would bundle like ISO's and MLS's into saleable groups comprising merchants in the same industries, possessing the same level of risk, and/or processing through the same acquiring banks. These bundled groups would command larger sales prices as the sheer number of merchants and ease of merging like groups and platforms is clearly more attractive to the buyer and acquiring bank.

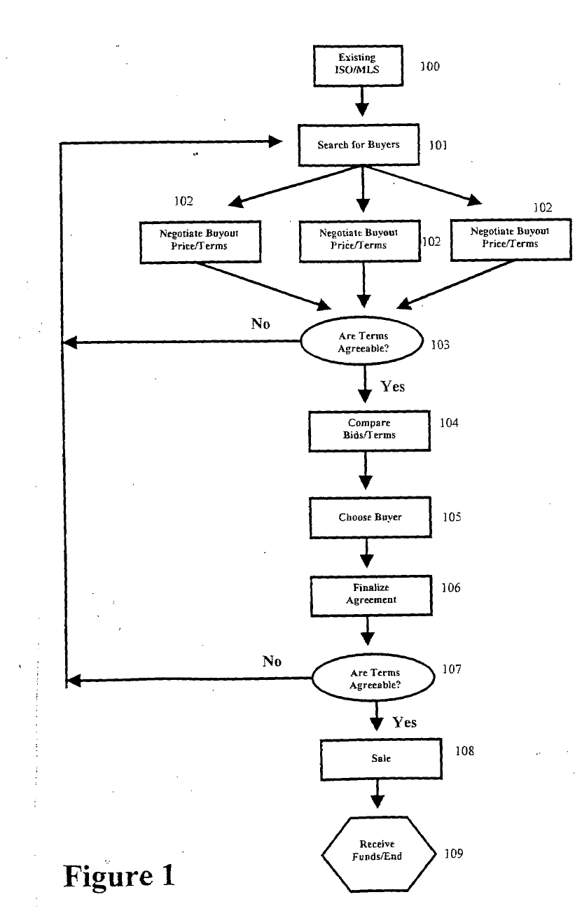

Referring to the drawings, FIG. 1 shows the prior, most common method for selling residuals in the industry. An existing ISO/MLS 100 would decide that it either wanted or needed to sell their current book of clients. A search for potential buyers 101 was then conducted. Previously, this search for buyers was limited to what the ISO/MLS's individual experience in the area of performing these types of transactions. In the past, time was also an issue as the individual ISO/MLS's were not able to devote all their time toward finding a potential buyer. Assuming several potential buyers could be found, the next step was negotiating terms with each buyer individually 102. After an agreement has been reached with the potential buyers, a preliminary agreement was worked out 103. If no agreement could be reached with the potential buyers, the process was started again 101. If acceptable terms were reached with multiple buyers, then the offers were compared with each other to find the most agreeable offer 104.

After determining the best offer, the particular buyer making the offer was contacted 105 and a final agreement was reached 106. Next, if the final agreement was acceptable for both parties 107, then the transaction was conducted and the sale actually completed 108. Thus, in past systems, if the agreement was not acceptable, the only corrective action to be taken was to restart the entire process 101. If the sale was actually conducted, then the final step is comprised of exchanging funds for the client list 109.

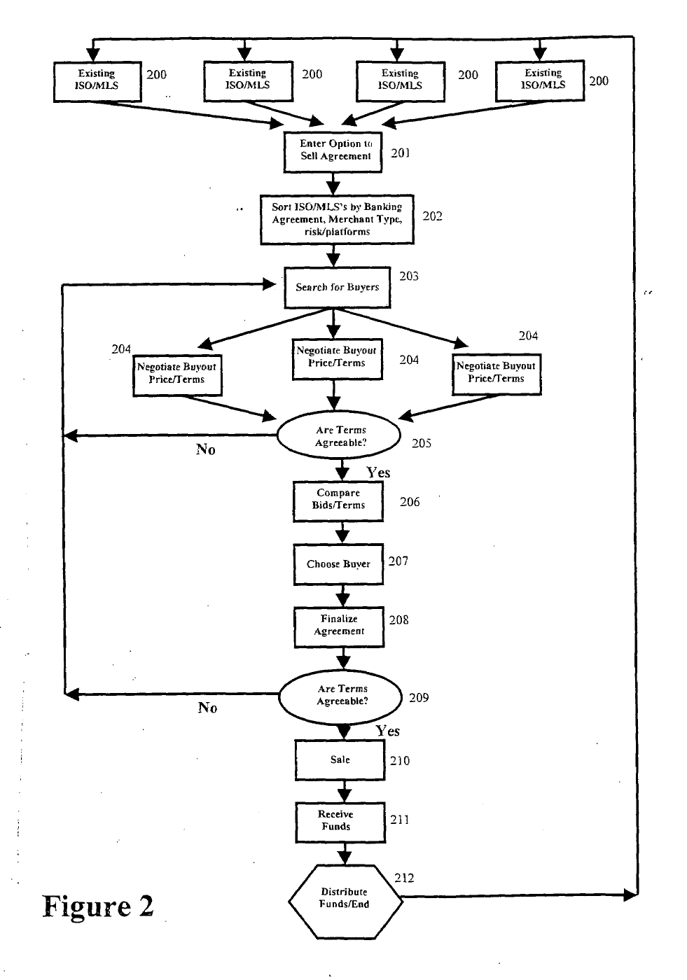

FIG. 2 illustrates the instant system and method for aggregating ISO/MLS's with other like ISO/MLS's to create a larger offering that will generate a higher sales price. The first step is for multiple existing ISO/MLS's 200 to enter into an option to sell agreement 201 with a company that is experienced in mergers and acquisitions. After obtaining multiple ISO/MLS's option to sell agreement, the ISO/MLS's need to be sorted and grouped according to banking agreement, merchant type and risks/platforms 202. After the sorting/grouping, a search for suitable buyers is conducted 203 and upon recognition of several potential buyers, a negotiation to determine potential buyout price/terms has to be performed 204. Upon completion of said negotiation, if the terms are determined to be agreeable, then the next step can be performed. If the terms are not agreeable, then, once again, a search for other potential buyers needs to be conducted 205. After determining multiple buyers with agreeable terms, these terms have to be compared with each other 206.

Next, a buyer is then chosen after determining the most beneficial terms 207. The agreement with the chosen buyer is then finalized 208. The finalized terms then need to be examined to make sure that they are still agreeable or else the search for buyers must be reinstituted 209. However, if the terms are agreeable, the sale is conducted 210 and the funds transferred 211. The funds are then distributed to the various ISO/MLS's to complete the process 212.

What is claimed is:

1. A business method for facilitating the transaction between a set Independent Sales Offices and a set of potential buyers comprising the steps of:
meeting with an individual of said set of Independent Sales Offices that demonstrate interest in selling a book of clients;
entering into an option to sell agreement with said set of Independent Sales Offices;
sorting said set of Independent Sales Offices before searching for potential buyers;
searching for said set of potential buyers;
negotiating with said set of potential buyers;
determining whether an offer from any of said set of potential buyers is acceptable;
comparing said offers of set of potential buyers which were deemed acceptable;
choosing said most suitable of said set of potential buyers;
finalizing a set of terms with said most suitable of said set of potential buyers;
confirming that said set of terms are agreeable;
conducting the actual sale;
receiving the funds; and,
distributing said funds among various said set of Independent Sales Offices.

2. The business method of claim 1 wherein said meeting with an individual of said set of Independent Sales Offices is conducted by an entity that is readily familiar with mergers and acquisitions in the Independent Sales Offices transactions.

3. The business method of claim 2 wherein said entering into an option to sell agreement is conducted by said entity with Independent Sales Offices transactions.

4. The business method of claim 3 wherein said sorting is achieved by grouping together said Independent Sales Offices by banking agreement.

5. The business method of claim 3 wherein said sorting is achieved by grouping together said Independent Sales Offices by merchant type.

6. The business method of claim 3 wherein said sorting is achieved by grouping together said Independent Sales Offices by risk.

7. The business method of claim 4 wherein said sorting is achieved by grouping together Independent Sales Offices by both banking agreement and merchant type.

8. The business method of claim 7 wherein said sorting is achieved by grouping together Independent Sales Offices by both banking agreement and risk.

9. The business method of claim 8 wherein said searching for buyers is conducted by said entity which is familiar with Independent Sales Offices transactions.

10. The business method of claim 9 wherein said negotiation with said buyers is conducted by said entity which is familiar with Independent Sales Offices transactions.

11. The business method of claim 10 wherein said determining whether an offer from any of said set of potential buyers is acceptable either allows business method for facilitating the transaction between a set Independent Sales Offices and a set of potential buyer comprising process to continue if said offer is acceptable or returns said process to the finding of potential buyers if the said offer is not acceptable.

12. The business method of claim 11 wherein said comparison of said offers by said buyers is made by said entity which is familiar with Independent Sales Offices transactions.

13. The business method of claim 12 wherein said choosing of said most suitable of said set of potential buyers is determined by said entity which is familiar with Independent Sales Offices transactions.

14. The business method of claim 13 wherein said finalizing of said terms with said most suitable of said set of potential buyers is performed by said entity which is familiar with Independent Sales Offices transactions.

15. The business method of claim 14 wherein said conducting of said actual sale is done by said most suitable of said set of potential buyers.

16. The business method of claim 15 wherein said method proceeds to a subsequent step if said set of terms are agreeable, but returns to searching for buyers if said set of terms are not agreeable.

17. The business method of claim 16 wherein said receiving of said funds is done by said entity which is familiar with Independent Sales Offices transactions.

18. The business method of claim 17 wherein said distribution of said funds is performed by said entity which is familiar with Independent Sales Offices transactions.

19. A business method for facilitating the transaction between a set of Merchant Level Sales Representatives and a set of potential buyers comprising the steps of:
meeting with an individual of said set of Merchant Level Sales Representatives that demonstrate interest in selling a book of clients;
entering into an option to sell agreement with said set of Merchant Level Sales Representatives;
sorting said set of Merchant Level Sales Representatives before searching for potential buyers;
searching for said set of potential buyers;
negotiating with said set of potential buyers;
determining whether an offer from any of set of potential buyers is acceptable;
comparing the offers of set of potential buyers which were deemed acceptable;
choosing the most suitable of said set of potential buyers;
finalizing the terms with said most suitable of said set of potential buyers;
confirming that said terms are agreeable;
conducting the actual sale;
receiving the finds; and,
distributing said funds among various said set of Merchant Level Sales Representatives.

20. A business method for facilitating the transaction between a set of Independent Sales Offices, a set of Merchant Level Sales Representatives and a set of potential buyers comprising the steps of:
meeting with an individual of said set of Independent Sales Offices and said set of Merchant Level Sales Representatives that demonstrate interest in selling a book of clients;
entering into an option to sell agreement with said set of Independent Sales Offices and said set of Merchant Level Sales Representatives;
sorting said set of Independent Sales Offices and said set of Merchant Level Sales Representatives before searching for potential buyers;
searching for said set of potential buyers;
negotiating with said set of potential buyers;
determining whether an offer from any of set of potential buyers is acceptable;
comparing the offers of set of potential buyers which were deemed acceptable;
choosing the most suitable of said set of potential buyers;
finalizing the terms with said most suitable of said set of potential buyers;
confirming that said terms are agreeable;
conducting the actual sale;
receiving the funds; and,
distributing said funds among various said set of Independent Sales Offices and said set of Merchant Level Sales Representatives.
